(19) United States
(12) Patent Application Publication
(10) Pub. No.: US 2026/0203760 A1
(43) Pub. Date: Jul. 16, 2026

(54) MOBILE PAYMENT TRUST SCORE USING VERY SMART WALLET

(71) Applicant: Wells Fargo Bank, N.A., San Francisco, CA (US)

(72) Inventors: Clifford R. Bloom, Minneapolis, MN (US); Kami J. Hanson, Columbus, MN (US); Eric J. Miller, Minneapolis, MN (US)

(21) Appl. No.: 19/025,124

(22) Filed: Jan. 16, 2025

(51) Int. Cl. G06Q 20/40; G06Q 20/32; G06Q 20/36; G06Q 20/38

(52) U.S. Cl. CPC G06Q 20/4016; G06Q 20/322; G06Q 20/36; G06Q 20/3825; G06Q 20/3829

(57) ABSTRACT

A system for generating a trust score for mobile payments using a transacting mobile wallet. The method involves receiving a transaction indication and digital identity data, which is cryptographically signed by an identity provider. The mobile wallet encrypts this data with a public encryption element of a trust score service and transmits the encrypted data for evaluation. The trust score service derives a trust score from previous transactions and a database of fraudulent activity, returning the trust score with a cryptographic signature. The mobile wallet validates the signature and displays the trust score. The system may provide feedback to update future trust scores and compare the score to predefined thresholds to manage transaction outcomes.

### TECHNICAL FIELD

Embodiments pertain to digital transaction security systems. Some embodiments relate to methods and systems for verifying identities and generating trust scores in mobile payment applications.

### BACKGROUND

Digital transactions may be classified based upon the type of payor and payee. For example, peer-to-peer (P2P) transactions are between two or more persons, business-to-business (B2B) transactions are between two or more businesses, and person-to-business (P2B) transactions are between persons and businesses. Mobile wallet payments have become increasingly popular as a method for conducting all of these types of digital transactions. A mobile wallet is a virtual wallet that stores payment card information on a mobile device. Users can make payments by using their smartphones, tablets, or smartwatches, eliminating the need for physical cards. Mobile wallets utilize technologies such as Near Field Communication (NFC), QR codes, and mobile applications to facilitate secure and convenient transactions.

In a typical mobile wallet payment process, the user first adds their payment card information to the mobile wallet application. This information is securely stored and often tokenized to enhance security. When making a payment, the user selects the mobile wallet as the payment method and authorizes the transaction, usually through biometric authentication (e.g., fingerprint or facial recognition) or a secure PIN. The mobile wallet then communicates with the payment terminal or online payment gateway to complete the transaction.

Mobile wallet payments can be used for various types of transactions, including P2P, B2B, and P2B. For P2P transactions, users can send money to friends or family members by selecting the recipient from their contact list and entering the payment amount. B2B transactions may involve businesses using mobile wallets to pay suppliers or service providers. P2B transactions typically occur in retail settings, where consumers use their mobile wallets to pay for goods and services at physical or online stores.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows a system diagram of a trust score system and messages exchanged during a transaction, according to some examples of the present disclosure.

FIG. 2 shows GUI illustrations of alternative examples of how the trust score may be utilized within a transaction, according to some examples of the present disclosure.

FIG. 3 shows a flowchart of a method for a transacting party computing device to obtain a trust score for use in a transaction, according to some examples of the present disclosure.

FIG. 4 illustrates a logical diagram of a computing device used in a trust score-enabled transaction and a trust score service, according to some examples of the present disclosure.

FIG. 5 illustrates a GUI of a user sending money to another user of the P2P payment service that is verified, according to some examples of the present disclosure.

FIG. 6 illustrates a block diagram of an example machine upon which any one or more of the techniques discussed herein may be performed, according to some examples of the present disclosure.

### DETAILED DESCRIPTION

Platforms facilitating digital transactions often become targets for fraudulent activities. Scammers exploit the lack of reliable methods to verify the identity and trustworthiness of the other party, leading to risks and uncertainties for legitimate users. The absence of identity verification in digital transactions exacerbates the problem, resulting in increased instances of fraud and financial loss. Existing solutions fail to provide a robust mechanism for ensuring the authenticity and reliability of transacting parties, thereby necessitating a more secure and trustworthy method to mitigate these risks.

Disclosed in some examples are methods, systems, devices, and machine-readable mediums for enhancing the security and trustworthiness of digital transactions by utilizing the digital identities of transacting parties that are part of their very smart mobile wallets. For example, by utilizing the identity stored in a mobile driver's license (mDL) or other digital identity, the identity of one or more transacting parties may be verified. In addition, in some examples, the transacting parties may utilize the obtained identity to also obtain a trust score from a centralized trust score service. This trust score may be based on a database storing information about previous transactions as well as fraudulent activity reports of one or more financial institutions. The trust score may provide transacting parties an additional layer of security and confidence in the transaction. The identity exchange and trust score may be implemented using a digital identity of transacting parties and may involve one or more encryption methods in order to ensure the security of the identity information.

In some examples, the system may cross-verify identity data from digital identity (e.g., mDL) data with payment sources already in the mobile wallet, further enhancing the reliability of the identity and trust score. If discrepancies are found between the mDL data and the payment card information in the mobile wallet, the system may flag the transaction for further review or reduce the trust score. This additional layer of verification helps ensure the consistency and reliability of the identity and trust score.

Additionally, for P2P payment service accounts (e.g., such as Zelle), the system may assign a “verified” status indicator to users whose mDL data matches their user account data, providing an immediate visual cue of trustworthiness.

The trust score service may be a centralized system designed to enhance the security and reliability of digital transactions by generating trust scores for transacting parties. This service leverages a comprehensive database that includes historical transaction data, reviews, and/or records of fraudulent activities from one or more financial institutions. By utilizing a digital identity of a transacting party and using that identity to reference the historical transaction data, records, and/or fraud reports, the trust score service can assess the trustworthiness of a transacting party based on their past behavior and interactions. The trust score may be generated and cryptographically signed by the trust score service to ensure its authenticity and integrity. This score provides an additional layer of security, enabling users to make informed decisions about the trustworthiness of their transacting partners. The trust score service continuously updates its database with new transaction data and feedback, ensuring that the trust scores remain accurate and reflective of the current trustworthiness of the users.

One example trust score may utilize transaction ratings of previous transactions left by transaction partners such as a star or numerical rating. The trust score may be an average rating. In some other examples, each transaction rating may be weighted by one or more of: the transaction amount (e.g., by weighting higher transaction amount transactions higher), by whether the parties have previous dealings (e.g., weighting transactions between frequent partners lower), and/or in some examples, weighting a person's rating of the other transacting party by the person's rating—that is, if the person doing the rating has a high rating, their ratings may be weighted higher than ratings of persons that have low ratings.

The identity verification and trust score system described herein can operate in both bi-directional and uni-directional modes, providing flexibility based on the requirements of the transaction. In a bi-directional verification scenario, both the payee and the payor can verify each other's identities and trust scores. This mutual verification process ensures that both parties have confidence in the authenticity and trustworthiness of their transacting partner, thereby reducing the risk of fraud from either side. For instance, the payee can verify the identity and trust score of the payor to ensure they are dealing with a legitimate individual, while the payor can similarly verify the payee's credentials and trust score to confirm the legitimacy of the recipient.

In a uni-directional verification scenario, only one party—either the payee or the payor—verifies the identity and trust score of the other party. This mode may be suitable for transactions where only one party needs assurance of the other's trustworthiness. For example, in a retail setting, a consumer (payor) may verify the trust score of the merchant (payee) to ensure they are purchasing from a reputable source. Conversely, in a peer-to-peer payment scenario, the recipient (payee) may verify the identity and trust score of the sender (payor) to confirm the legitimacy of the payment. The flexibility to operate in either bi-directional or uni-directional modes allows the system to cater to a wide range of transaction types and security requirements.

A party may obtain a trust score for a transacting partner either before a transaction is initiated or as part of the transaction itself. Initially, a digital identity is transmitted from one transacting party to another. This transmission may be optical, such as through a QR code, or sent via radio frequency (RF) technologies like Near Field Communication (NFC). Once the digital identity is received, it is transmitted to the trust score service for evaluation.

The trust score service then processes the digital identity, which includes verifying the identity by validating the cryptographic signature associated with the digital identity. This ensures that the identity information is authentic and has not been tampered with. The trust score service leverages its comprehensive database, which includes historical transaction data and records of fraudulent activities from one or more financial institutions, to assess the trustworthiness of the transacting party. Past transactions involving the digital identity may be obtained from the database using the digital identity, or a value derived from it (e.g., such as a hash), as a key in the database.

Based on the returned records, the trust score service generates a trust score that reflects the reliability and trustworthiness of the transacting party. This trust score may be cryptographically signed by the trust score service to ensure its authenticity and integrity. The trust score is then returned to the requesting party, providing them with an additional layer of security and confidence in the transaction. This process ensures that the identity of the user is verified and that the trust score accurately reflects their trustworthiness, thereby mitigating the risk of fraud and enhancing the overall security of digital transactions.

In some examples, the trust score may be displayed prior to, or during the transaction, and the user may have to manually determine whether to proceed. In other examples, a user may have rules that automatically approve, deny, or confirm transactions based upon a trust score. For example, during a tap-to-pay transaction, in order to decrease any transaction friction, if the trust score equals or exceeds a first threshold, the transaction proceeds without interruption. The trust score may still be displayed as part of the transaction. If the trust score is below the first threshold but is equal to or greater than a second threshold, the user may be prompted with the trust score and GUI controls that allow the user to either proceed-with or reject the transaction. If the trust score is below the second threshold, the transaction may be cancelled. In still other examples, if the trust score is below a particular threshold, the transaction may either be automatically approved or canceled if the user does not intervene before a timeout period.

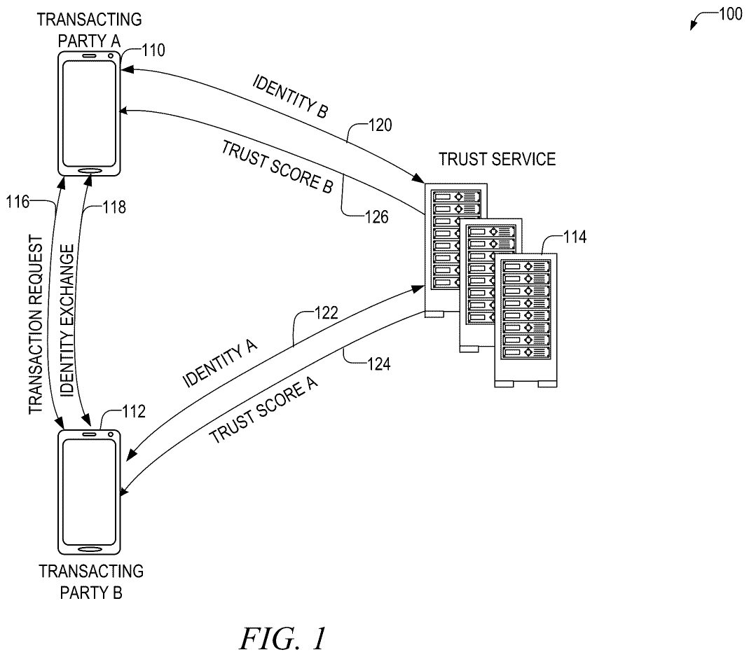

FIG. 1 shows a system diagram 100 of a trust score system and messages exchanged during a transaction according to some examples of the present disclosure. The diagram includes Transacting Party A 110 and Transacting party B 112, both of which are involved in a digital transaction using respective computing devices. The transaction may be P2P, P2B, B2B, or the like. The Trust Service 114 acts as a centralized entity responsible for generating trust scores based on the identities and transaction history of the transacting parties.

Transacting party A 110 and transacting party B 112 initiate a transaction with transaction request messaging 116. Following the initiation of the transaction, or prior to initiating the transaction, identity exchange messaging 118 occurs, where the digital identities of both parties are shared. While FIG. 1 depicts bi-directional identity sharing, other examples may include only one transacting party sharing their digital identities. Transacting party A 110 receives the digital identity of transacting party B 112 and sends the identity of transacting party B 120 to the trust service 114, while transacting party B 112 receives the digital identity of transacting party A 110 and sends the digital identity of transacting party A 122 to the trust service 114. This exchange allows the trust service 114 to verify the identities and assess the trustworthiness of each party. In some examples, the digital identities may be verified by the computing devices of the transacting parties and displayed to the respective parties to allow them to verify that the digital identities match the person they thought they were transacting with. While a single trust service 114 is displayed, in other examples, multiple independent trust services 114 may be utilized.

The trust service 114 processes the received identities and generates trust scores for both parties. Trust score B 124 is sent back to transacting party A 110, and trust score A 126 is sent back to transacting party B 112. These trust scores provide an additional layer of security and confidence in the transaction by reflecting the reliability and trustworthiness of the transacting parties based on their past behavior and interactions. The scores may also be displayed to the users, allowing them to manually review and approve the transaction if necessary, or automatically determine the transaction's outcome based on predefined thresholds.

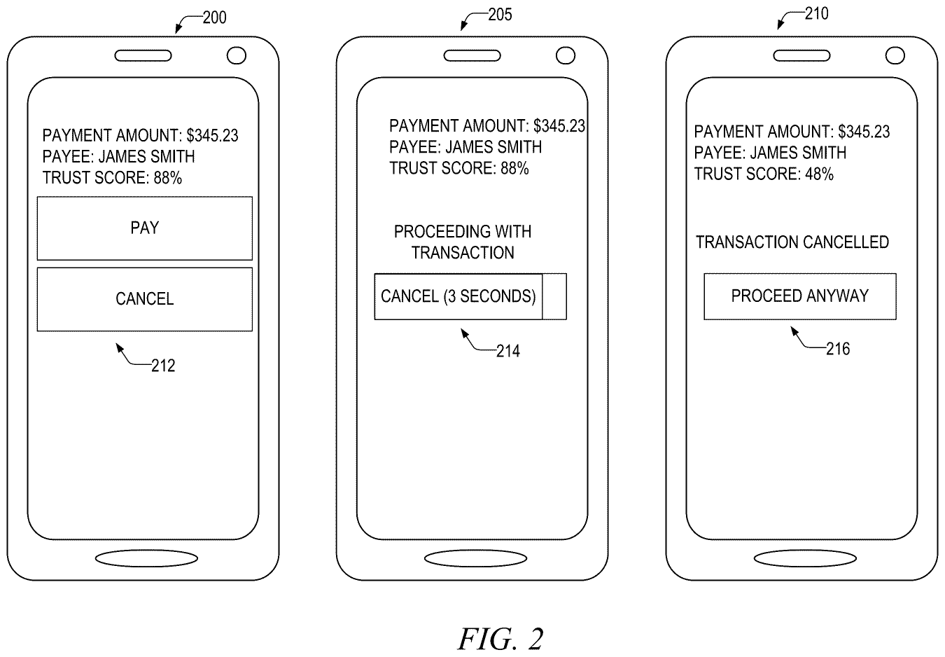

FIG. 2 shows GUI 200, GUI 205, and GUI 210, which illustrate alternative examples of how the trust score may be utilized within a transaction. GUI 200 displays the trust score before the user confirms the transaction. The interface includes selection elements 212, allowing the user to either proceed with the payment or cancel the transaction. This interface provides the user with the trust score, enabling an informed decision based on the trustworthiness of the payee. In some examples, GUI 200 may be presented in examples in which the trust score is provided prior to commencement of the transaction.

GUI 205 presents an example where the trust score is presented after the transaction has commenced. The interface includes a cancel element 214, which provides the user with a limited time to cancel the transaction if the user deems the trust score unsatisfactory. This feature allows the user to reassess the transaction's security and make a decision within a specified timeframe, enhancing the control over the transaction process.

GUI 210 demonstrates a scenario where the transaction is automatically canceled due to a low trust score (which may be specified by threshold trust scores). The interface includes a proceed selection element 216, offering the user the option to override the cancellation and continue with the transaction. This flexibility allows the user to make decisions based on personal judgment, even when the trust score falls below a predefined threshold.

In some examples, the GUIs may be based upon the rule-based thresholds to determine the actions available to the user based on the trust score. For instance, if the trust score meets or exceeds a first threshold, the transaction may proceed without interruption. If the score is below the first threshold but above a second threshold, GUI 205 allows the user to review and potentially cancel the transaction. In cases where the trust score falls below the second threshold, GUI 210 automatically cancels the transaction but provides an option to override, allowing the user to proceed if they choose. These rules ensure that users are informed and empowered to make decisions that align with their security preferences and risk tolerance.

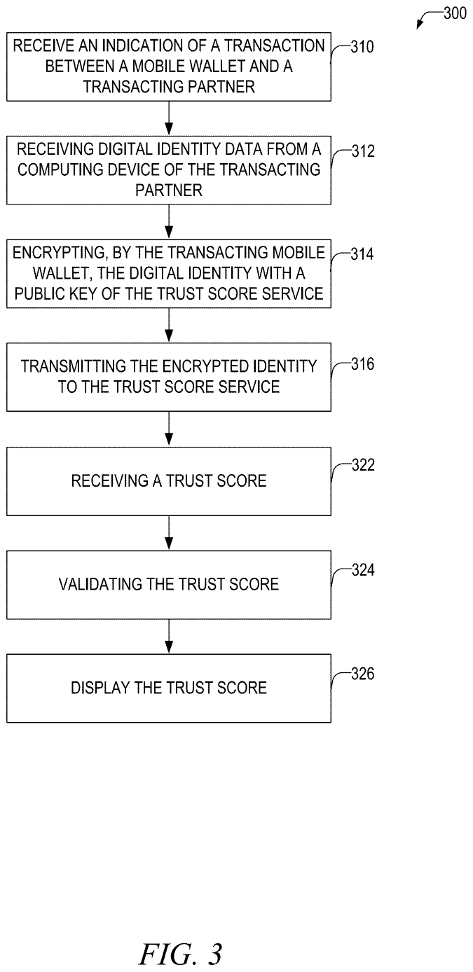

FIG. 3 shows a flowchart of a method 300 for a transacting party computing device to obtain a trust score for use in a transaction. At operation 310, the method begins with receiving an indication of a transaction between a mobile wallet and a transacting partner. This step involves the mobile wallet executing on a computing device, detecting a transaction initiation with a transacting partner. The transaction may be initiated using a tap-to-pay NFC communication, a selection of a payment element, a user input from the user, or the like.

At operation 312, the method involves receiving digital identity data from a computing device of the transacting partner. The digital identity data is cryptographically signed by an identity provider and provided by the mobile wallet of the transacting partner, ensuring the authenticity of the identity information. The digital identity may be received wirelessly, e.g., using radio waves, optical scanning, or the like. In some examples, the mobile wallet may verify the digital identity using the cryptographic signature and the public key of the digital identifier's issuer.

Following the receipt of the digital identity data, at operation 314, the transacting mobile wallet encrypts the digital identity with a public key of the trust score service. This encryption step secures the identity data, ensuring that only the trust score service can decrypt and access the information. The public key may be obtained from a certificate authority.

At operation 316, the encrypted identity is then transmitted to the trust score service. This transmission enables the trust score service to process the identity data and generate a trust score. At operation 322, upon successful transmission, the method involves receiving a trust score from the trust score service. The trust score is derived by the trust score service from previous transactions and a database of fraudulent activity, and the trust score includes a cryptographic signature of the trust score service, ensuring authenticity of the trust score. The received trust score may include a cryptographic signature of the trust score service to ensure that the trust score is from the trust service.

At operation 324, the next step is validating the trust score. This validation involves using the public key of the trust score service to verify the cryptographic signature, confirming that the trust score is genuine and has not been tampered with.

At operation 326, the method concludes with displaying the trust score. The mobile wallet presents the trust score to the user, providing an additional layer of security and confidence in the transaction by reflecting the reliability and trustworthiness of the transacting partner. In some examples, one or more automatic actions may be taken based upon the trust score and one or more rules. Actions may include canceling the transaction, approving the transaction, or the like.

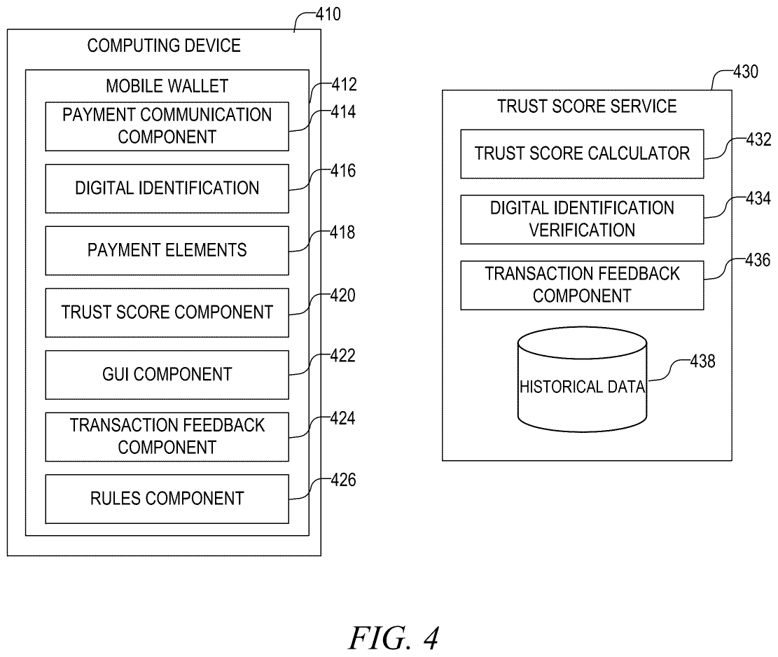

FIG. 4 illustrates a logical diagram of a computing device 410 used in a trust score-enabled transaction and a trust score service 430 according to some examples of the present disclosure. The computing device 410 includes a mobile wallet 412, which comprises several components, including a payment communication component 414, digital identification component 416, one or more payment elements 418, trust score component 420, GUI component 422, transaction feedback component 424, and rules component 426.

The payment communication component 414 facilitates secure transaction communications between the mobile wallet and other devices. It utilizes technologies such as NFC and QR codes to transmit payment information and digital identity information efficiently. This component ensures that all transaction data is encrypted and securely transmitted to prevent unauthorized access.

The digital identification component 416 manages the storage and verification of identity data, such as mobile driver's licenses (mDLs). The digital identification component 416 both stores and manages the digital identity data (such as mDLs) of the user of the computing device 410 as well as verifying the digital identity data of a transaction partner. It ensures that the identity data is cryptographically signed and validated before use in transactions. The digital identification component 416 allows for verification of the authenticity of the transacting party's identity, reducing the risk of fraud.

One or more payment elements 418 store various payment information, including credit card details and bank account information. This component securely encrypts and tokenizes payment data to protect sensitive information. It allows users to select different payment methods for transactions, providing flexibility and convenience.

The trust score component 420 interacts with the trust score service to obtain and display trust scores. It sends encrypted identity data obtained by the payment communication component 414 (either before, or during a transaction) to the trust score service and receives the calculated trust score in return. This component ensures that the trust score is validated and accurately reflects the transacting party's trustworthiness.

The GUI component 422 provides graphical user interfaces for transaction interactions, displaying trust scores and transaction options. It allows users to make informed decisions based on the trust score, offering options to proceed, cancel, or override transactions. In some examples, the GUI component 422 provides GUIs such as those shown in FIG. 2.

The transaction feedback component 424 collects and sends feedback to the trust score service, contributing to future trust scores of the transacting parties. This component gathers user feedback on transaction outcomes and any discrepancies encountered. This feedback is used to update the trust score service's database, ensuring that trust scores remain current and reliable.

The rules component 426 applies predefined rules to manage transaction decisions based on trust scores. It may evaluate trust scores against set thresholds to determine whether a transaction should proceed, be flagged for review, or be canceled. This component empowers users to customize their security preferences and risk tolerance.

The trust score service 430 may be a separate, network-based service that communicates with authorized computing devices, such as computing device 410, using an API to provide trust scores for transactions. Trust score service 430, in some examples, may be hosted in association with one or more financial services, such as banks. The trust score service 430 may utilize bank fraud information to assist in generating the trust score. The trust score service 430 communicates with the computing device 410 via a secure network connection, utilizing an API to exchange encrypted identity data and trust scores. This communication ensures that the trust score service can receive identity data from the computing device 410, process it, and return a validated trust score to the mobile wallet for display and further action.

The trust score service 430 may include a trust score calculator 432 for generating trust scores based on transaction data and historical records. As previously described, the trust score may be a simple ratings system that averages previous transaction ratings of users by their transaction partners. In other examples, each rating may be weighted by transaction amount. In still other examples, the trust score service 430 calculates the trust score by leveraging a combination of historical transaction data, user feedback, and fraud reports stored in the historical data storage 438.

For example, the trust score T for a transacting party may be computed using the formula:

$$T = \frac{{\sum }_{i = 1}^{n} ( {R}_{i} \times {W}_{i} )}{n}$$

where Rᵢ represents the rating given by a transaction partner for the i-th transaction, and Wᵢ is the weight assigned to that transaction. The weight Wᵢ may be determined based on factors such as transaction amount, frequency of transactions with the same partner, and the trustworthiness of the rating party. Higher transaction amounts and ratings from highly rated users are given greater weight. Additionally, the trust score is adjusted based on recent feedback and any discrepancies reported in identity verification, ensuring that the score accurately reflects the current trustworthiness of the user.

In some examples, the weight may be calculated by the formula:

$${W}_{i} = ( \frac{{A}_{i}}{{A}_{max}} ) \times ( \frac{1}{{F}_{i} + 1} ) \times ( \frac{{T}_{i}}{{T}_{max}} )$$

Where Aᵢ is the transaction amount, normalized by the maximum transaction amount Aₘₐₓ in the dataset. Fᵢ is the frequency of transactions with the same partner, Tᵢ is the trust score of the rating party, normalized by the maximum trust score Tₘₐₓ.

The digital identification verification component 434 ensures the authenticity of identity data by validating cryptographic signatures. It utilizes the public key of the issuing entity to verify the signature of the data.

In some examples, if the digital identity of the user does not match the identity associated with payment elements in the user's mobile wallet, the system may reduce the trust score by a prespecified amount, reduce the weighting of transactions, or the like. For example, during a transaction, the user may utilize a payment element to complete the transaction. This payment element may be associated, within a payment system, with user information. If the digital identifier that is supplied when calculating the trust score does not match this information, the system may reduce the trust score by a prespecified amount.

Historical data 438 is used to assess the trustworthiness of transacting parties, ensuring accurate and reliable trust score calculations. It includes records and ratings of past transactions and any reported fraudulent activities. In some examples, the historical data 438 may also include fraud claims data of a financial institution, such as a bank that indicates potential patterns of fraud, such as amounts of transactions, payees, and other context. A match against a payment that shows patterns of fraud (such as matching specific amount, payee, location, and/or other context of a fraudulent transaction or a pattern of fraudulent transactions) may be used to reduce the trust score.

For example, if a transaction amount matches a value frequently used in fraudulent schemes, or if the payee is linked to previous fraudulent activities, these factors can trigger a reduction in the trust score (e.g., by a prespecified amount). Similarly, if the transaction occurs in a location known for high fraud rates, this geographic context can also influence the trust score negatively (e.g., by a specified amount for each geographical location or area).

Moreover, the system may analyze patterns over time, such as repeated transactions with the same suspicious payee or consistent transaction amounts that align with fraudulent profiles. By integrating these insights, the trust score service can dynamically adjust the trust score, reflecting the increased risk associated with the transaction. This proactive approach helps in mitigating fraud by alerting users to potential threats and allowing them to make informed decisions about proceeding with the transaction.

The transaction feedback component 436 processes feedback from transactions to update trust scores. It incorporates user feedback and transaction outcomes into the trust score calculations. This component ensures that trust scores evolve with changing transaction patterns and user behavior.

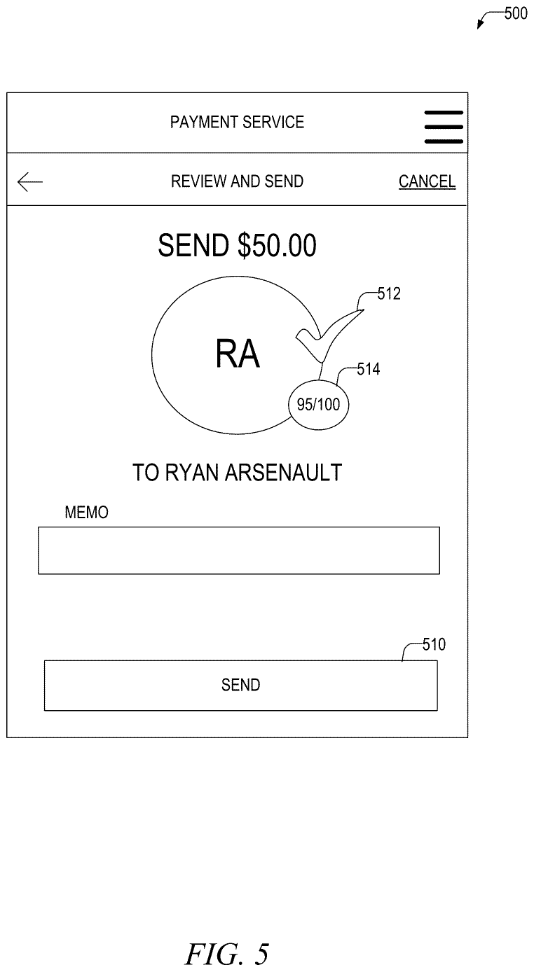

In some examples, for existing P2P payment services, such as ZELLE®, the system may assign a visual indicator if the account details on the existing P2P payment services match the digital identifier. For example, the user may select an option within an application of the P2P payment service to verify their identity. The mobile wallet of the user's device then transmits the digital identity along with the payment service account identifier to the payment service. A digital identification verification component, such as digital identification verification component 434 executing on the payment service may then verify the digital identity and if the information in the digital identity matches the information the user gave when they setup their account, the system then adds a “verified” indicator on the user's icon or avatar that displays on other user's screens when they engage in a transaction to that person. The indicator gives them confidence that this user is who they say they are. For example, FIG. 5 illustrates a GUI 500 of a user sending money to another user of the P2P payment service that is verified. For example, at the screen where the user is about to confirm the payment via a button 510, a badge or other UI indicator such as checkmark 512 confirms that the user's digital identity matches their account information. In addition, in some examples, a trust score may be displayed 514.

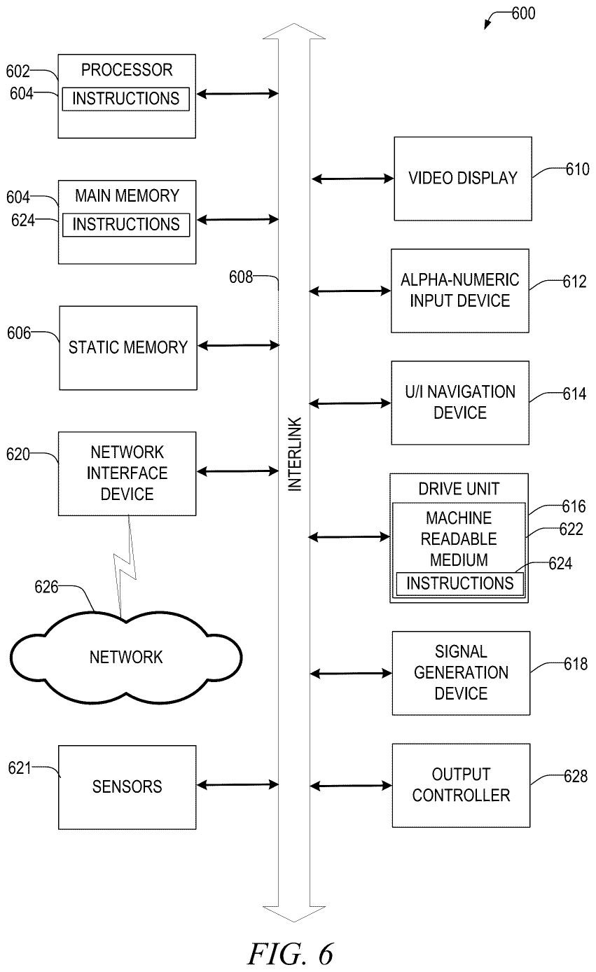

FIG. 6 illustrates a block diagram of an example machine 600 upon which any one or more of the techniques (e.g., methodologies) discussed herein may be performed. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be in the form of a desktop, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations. Machine 600 may be or be configured to be the computing devices shown in FIG. 1; produce the GUIs of FIG. 2 and FIG. 5; perform the methods of FIG. 3; and include the components of FIG. 4.

Examples, as described herein, may include, or may operate on one or more logic units, components, or mechanisms (hereinafter “components”). Components are tangible entities (e.g., hardware) capable of performing specified operations and may be configured or arranged in a certain manner. In an example, circuits may be arranged (e.g., internally or with respect to external entities such as other circuits) in a specified manner as a component. In an example, the whole or part of one or more computer systems (e.g., a standalone, client or server computer system) or one or more hardware processors may be configured by firmware or software (e.g., instructions, an application portion, or an application) as a component that operates to perform specified operations. In an example, the software may reside on a machine readable medium. In an example, the software, when executed by the underlying hardware of the component, causes the hardware to perform the specified operations of the component.

Accordingly, the term “component” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which component are temporarily configured, each of the components need not be instantiated at any one moment in time. For example, where the components comprise a general-purpose hardware processor configured using software, the general-purpose hardware processor may be configured as respective different components at different times. Software may accordingly configure a hardware processor, for example, to constitute a particular module at one instance of time and to constitute a different component at a different instance of time.

Machine (e.g., computer system) 600 may include one or more hardware processors, such as processor 602. Processor 602 may be a central processing unit (CPU), a graphics processing unit (GPU), a hardware processor core, or any combination thereof. Machine 600 may include a main memory 604 and a static memory 606, some or all of which may communicate with each other via an interlink (e.g., bus) 608. Examples of main memory 604 may include Synchronous Dynamic Random-Access Memory (SDRAM), such as Double Data Rate memory, such as DDR4 or DDR5. Interlink 608 may be one or more different types of interlinks such that one or more components may be connected using a first type of interlink and one or more components may be connected using a second type of interlink. Example interlinks may include a memory bus, a peripheral component interconnect (PCI), a peripheral component interconnect express (PCIe) bus, a universal serial bus (USB), or the like.

The machine 600 may further include a display unit 610, an alphanumeric input device 612 (e.g., a keyboard), and a user interface (UI) navigation device 614 (e.g., a mouse). In an example, the display unit 610, input device 612 and UI navigation device 614 may be a touch screen display. The machine 600 may additionally include a storage device (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 may include a machine readable medium 622 on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

While the machine readable medium 622 is illustrated as a single medium, the term “machine readable medium” may include a single medium or multiple media (e.g., a centralized or distributed database, and/or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 624 may further be transmitted or received over a communications network 626 using a transmission medium via the network interface device 620. The Machine 600 may communicate with one or more other machines wired or wirelessly utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks such as an Institute of Electrical and Electronics Engineers (IEEE) 802.11 family of standards known as Wi-Fi®, an IEEE 802.15.4 family of standards, a 5G New Radio (NR) family of standards, a Long Term Evolution (LTE) family of standards, a Universal Mobile Telecommunications System (UMTS) family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. In some examples, the network interface device 620 may wirelessly communicate using Multiple User MIMO techniques.

### OTHER NOTES AND EXAMPLES

Example 1 is a computer-implemented method for generating a trust score for mobile payments, the method comprising: receiving an indication, by a mobile wallet executing on a computing device, an indication of a transaction between the mobile wallet and a transacting partner; receiving, by the mobile wallet executing on the computing device, digital identity data from a computing device of the transacting partner, the digital identity data cryptographically signed by an identity provider and provided by a mobile wallet of the transacting partner; encrypting, by the mobile wallet, the digital identity data with a public key of a trust score service to create an encrypted identity; transmitting, by the transacting mobile wallet, the encrypted identity to the trust score service; receiving, by the transacting mobile wallet, a trust score from the trust score service, the trust score is derived from previous transactions and a database of fraudulent activity, the trust score including a cryptographic signature of the trust score service; validating, by the mobile wallet, the cryptographic signature of the trust score service using the public key of the trust score service; and displaying, by the transacting mobile wallet, the trust score.

In Example 2, the subject matter of Example 1 includes, providing feedback on the transaction to the trust score service, wherein the feedback is used to update trust scoring for future transactions.

In Example 3, the subject matter of Examples 1-2 includes, comparing the trust score to a predefined threshold and automatically cancelling or blocking the transaction if the trust score is below the predefined threshold.

In Example 4, the subject matter of Examples 1-3 includes, receiving an indication that the transacting partner has payment elements that do not match the digital identity data and in response canceling or blocking the transaction.

In Example 5, the subject matter of Examples 1~4 includes, displaying the digital identity data of the transacting partner on the transacting mobile wallet.

In Example 6, the subject matter of Examples 1-5 includes, sending, by the transacting mobile wallet, transaction details to the trust score service, wherein the transaction details are used by the trust score service to create or update the trust score.

In Example 7, the subject matter of Example 6 includes, wherein the transaction details include at least one of the following: transaction amount, transaction date and time, location of the transaction, and type of transaction.

In Example 8, the subject matter of Examples 1-7 includes, receiving, by the transacting mobile wallet, a verified status indicator from the trust score service, wherein the verified status indicator is based on a match between the digital identity data and user account data on a payment service of the transacting partner.

Example 9 is a computing device for generating a trust score for mobile payments, the computing device comprising: a hardware processor; a memory, the memory storing instructions, which when executed by the hardware processor cause the computing device to perform operations comprising: receiving an indication of a transaction between a mobile wallet and a transacting partner; receiving digital identity data from a computing device of the transacting partner, the digital identity data cryptographically signed by an identity provider and provided by a mobile wallet of the transacting partner; encrypting the digital identity data with a public key of a trust score service to create an encrypted identity; transmitting the encrypted identity to the trust score service; receiving a trust score from the trust score service, the trust score derived from previous transactions and a database of fraudulent activity, the trust score including a cryptographic signature of the trust score service; validating the cryptographic signature of the trust score service using the public key of the trust score service; and displaying the trust score.

In Example 10, the subject matter of Example 9 includes, wherein the operations further comprise: providing feedback on the transaction to the trust score service, wherein the feedback is used to update trust scoring for future transactions.

In Example 11, the subject matter of Examples 9-10 includes, wherein the operations further comprise: comparing the trust score to a predefined threshold and automatically cancelling or blocking the transaction if the trust score is below the predefined threshold.

In Example 12, the subject matter of Examples 9-11 includes, wherein the operations further comprise: receiving an indication that the transacting partner has payment elements that do not match the digital identity data and in response canceling or blocking the transaction.

In Example 13, the subject matter of Examples 9-12 includes, wherein the operations further comprise: displaying the digital identity data of the transacting partner on the transacting mobile wallet.

In Example 14, the subject matter of Examples 9-13 includes, wherein the operations further comprise: sending transaction details to the trust score service, wherein the transaction details are used by the trust score service to create or update the trust score.

In Example 15, the subject matter of Example 14 includes, wherein the transaction details include at least one of the following: transaction amount, transaction date and time, location of the transaction, and type of transaction.

In Example 16, the subject matter of Examples 9-15 includes, wherein the operations further comprise: receiving a verified status indicator from the trust score service, wherein the verified status indicator is based on a match between the digital identity data and user account data on a payment service of the transacting partner.

Example 17 is a non-transitory machine-readable medium, storing instructions for generating a trust score for mobile payments, the instructions, which when executed, cause a machine to perform operations comprising: receiving an indication of a transaction between a mobile wallet and a transacting partner; receiving digital identity data from a computing device of the transacting partner, the digital identity data cryptographically signed by an identity provider and provided by a mobile wallet of the transacting partner; encrypting the digital identity data with a public key of a trust score service to create an encrypted identity; transmitting the encrypted identity to the trust score service; receiving a trust score from the trust score service, the trust score derived from previous transactions and a database of fraudulent activity, the trust score including a cryptographic signature of the trust score service; validating the cryptographic signature of the trust score service using the public key of the trust score service; and displaying the trust score.

In Example 18, the subject matter of Example 17 includes, wherein the operations further comprise: providing feedback on the transaction to the trust score service, wherein the feedback is used to update trust scoring for future transactions.

In Example 19, the subject matter of Examples 17-18 includes, wherein the operations further comprise: comparing the trust score to a predefined threshold and automatically cancelling or blocking the transaction if the trust score is below the predefined threshold.

In Example 20, the subject matter of Examples 17-19 includes, wherein the operations further comprise: receiving an indication that the transacting partner has payment elements that do not match the digital identity data and in response canceling or blocking the transaction.

In Example 21, the subject matter of Examples 17-20 includes, wherein the operations further comprise: displaying the digital identity data of the transacting partner on the transacting mobile wallet.

In Example 22, the subject matter of Examples 17-21 includes, wherein the operations further comprise: sending transaction details to the trust score service, wherein the transaction details are used by the trust score service to create or update the trust score.

In Example 23, the subject matter of Example 22 includes, wherein the transaction details include at least one of the following: transaction amount, transaction date and time, location of the transaction, and type of transaction.

In Example 24, the subject matter of Examples 17-23 includes, wherein the operations further comprise: receiving a verified status indicator from the trust score service, wherein the verified status indicator is based on a match between the digital identity data and user account data on a payment service of the transacting partner.

Example 25 is at least one machine-readable medium including instructions that, when executed by processing circuitry, cause the processing circuitry to perform operations to implement of any of Examples 1-24.

Example 26 is an apparatus comprising means to implement of any of Examples 1-24.

Example 27 is a system to implement of any of Examples 1-24.

Example 28 is a method to implement of any of Examples 1-24.

1. A computer-implemented method for generating a trust score for mobile payments, the method comprising:
receiving an indication, by a mobile wallet executing on a computing device, of a transaction between the mobile wallet and a transacting partner;
receiving, by the mobile wallet executing on the computing device, digital identity data from a computing device of the transacting partner, the digital identity data cryptographically signed by an identity provider and provided by a mobile wallet of the transacting partner,
encrypting, by the mobile wallet executing on the computing device, the digital identity data with a public key of a trust score service to create an encrypted identity;
transmitting, by the mobile wallet executing on the computing device, the encrypted identity to the trust score service;
receiving, by the mobile wallet executing on the computing device, a trust score from the trust score service, the trust score is derived from previous transactions and a database of fraudulent activity, the trust score including a cryptographic signature of the trust score service;
validating, by the mobile wallet executing on the computing device, the cryptographic signature of the trust score service using the public key of the trust score service;
determining that the trust score exceeds a specified threshold;
responsive to determining that the trust score exceeds the specified threshold:
providing, by the mobile wallet executing on the computing device, a user interface, the user interface comprising the trust score, a countdown timer, and a selectable option to cancel the transaction; and
determining that a user has not selected the selectable option to cancel the transaction prior to expiration of the countdown timer, and in response automatically performing the transaction.

2. The method of claim 1, further comprising providing feedback on the transaction to the trust score service, wherein the feedback is used to update trust scoring for future transactions.

3. (canceled)

4. The method of claim 1, further comprising receiving an indication that the transacting partner has payment elements that do not match the digital identity data and in response canceling or blocking the transaction.

5. The method of claim 1, further comprising displaying the digital identity data of the transacting partner on the mobile wallet executing on the computing device.

6. The method of claim 1, further comprising:
sending, by the mobile wallet executing on the computing device, transaction details to the trust score service, wherein the transaction details are used by the trust score service to create or update the trust score.

7. The method of claim 6, wherein the transaction details include at least one of the following: transaction amount, transaction date and time, location of the transaction, and type of transaction.

8. The method of claim 1, further comprising:
receiving, by the mobile wallet executing on the computing device, a verified status indicator from the trust score service, wherein the verified status indicator is based on a match between the digital identity data and user account data on a payment service of the transacting partner.

9. A computing device for generating a trust score for mobile payments, the computing device comprising:
a hardware processor;
a memory, the memory storing instructions, which when executed by the hardware processor cause the computing device to perform operations comprising:
receiving an indication of a transaction between a mobile wallet and a transacting partner;
receiving digital identity data from a computing device of the transacting partner, the digital identity data cryptographically signed by an identity provider and provided by a mobile wallet of the transacting partner;
encrypting, by the mobile wallet executing on the computing device, the digital identity data with a public key of a trust score service to create an encrypted identity;
transmitting, by the mobile wallet executing on the computing device, the encrypted identity to the trust score service;
receiving, by the mobile wallet executing on the computing device, a trust score from the trust score service, the trust score is derived from previous transactions and a database of fraudulent activity, the trust score including a cryptographic signature of the trust score service;
validating, by the mobile wallet executing on the computing device, the cryptographic signature of the trust score service using the public key of the trust score service;
determining that the trust score exceeds a specified threshold;
responsive to determining that the trust score exceeds the specified threshold;
providing, by the mobile wallet executing on the computing device, a user interface, the user interface comprising the trust score, a countdown timer, and a selectable option to cancel the transaction; and
determining that a user has not selected the selectable option to cancel the transaction prior to expiration of the countdown timer, and in response, automatically performing the transaction.

10. The computing device of claim 9, wherein the operations further comprise: providing feedback on the transaction to the trust score service, wherein the feedback is used to update trust scoring for future transactions.

11. (canceled)

12. The computing device of claim 9, wherein the operations further comprise: receiving an indication that the transacting partner has payment elements that do not match the digital identity data and in response canceling or blocking the transaction.

13. The computing device of claim 9, wherein the operations further comprise: displaying the digital identity data of the transacting partner on the mobile wallet executing on the computing device.

14. The computing device of claim 9, wherein the operations further comprise: sending transaction details to the trust score service, wherein the transaction details are used by the trust score service to create or update the trust score.

15. The computing device of claim 14, wherein the transaction details include at least one of the following: transaction amount, transaction date and time, location of the transaction, and type of transaction.

16. The computing device of claim 9, wherein the operations further comprise: receiving a verified status indicator from the trust score service, wherein the verified status indicator is based on a match between the digital identity data and user account data on a payment service of the transacting partner.

17. A non-transitory machine-readable medium, storing instructions for generating a trust score for mobile payments, the instructions, which when executed, cause a machine to perform operations comprising:
receiving an indication of a transaction between a mobile wallet and a transacting partner;
receiving digital identity data from a computing device of the transacting partner, the digital identity data cryptographically signed by an identity provider and provided by a mobile wallet of the transacting partner;
encrypting, by the mobile wallet executing on the computing device, the digital identity data with a public key of a trust score service to create an encrypted identity;
transmitting, by the mobile wallet executing on the computing device, the encrypted identity to the trust score service;
receiving, by the mobile wallet executing on the computing device, a trust score from the trust score service, the trust score is derived from previous transactions and a database of fraudulent activity, the trust score including a cryptographic signature of the trust score service;
validating, by the mobile wallet executing on the computing device, the cryptographic signature of the trust score service using the public key of the trust score service;
determining that the trust score exceeds a specified threshold;
responsive to determining that the trust score exceeds the specified threshold:
providing, by the mobile wallet executing on the computing device, a user interface, the user interface comprising the trust score, a countdown timer, and a selectable option to cancel the transaction; and
determining that a user has not selected the selectable option to cancel the transaction prior to expiration of the countdown timer, and in response, automatically performing the transaction.

18. The non-transitory machine-readable medium of claim 17, wherein the operations further comprise: providing feedback on the transaction to the trust score service, wherein the feedback is used to update trust scoring for future transactions.

19. (canceled)

20. The non-transitory machine-readable medium of claim 17, wherein the operations further comprise: receiving an indication that the transacting partner has payment elements that do not match the digital identity data and in response canceling or blocking the transaction.
